(19) United States
(12) Patent Application Publication
(10) Pub. No.: US 2015/0110567 A1
(43) Pub. Date: Apr. 23, 2015

(54) Modular Reamer System

(71) Applicant: Kennametal, Inc., Latrobe, PA (US)

(72) Inventors: Li Ning, Pleasant Unity, PA (US); Thomas Bobos, Morton Grove, IL (US)

(73) Assignee: Kennametal, Inc., Latrobe, PA (US)

(21) Appl. No.: 14/057,551

(22) Filed: Oct. 18, 2013

(51) Int. Cl. B23D 77/00

(52) U.S. Cl. CPC B23D 77/006; B23D 2277/02; B23D 2277/067; B23D 2277/2407; B23D 2277/2464; B23D 2277/60
USPC 408/59; 29/447; 29/426.1

(57) ABSTRACT

A rotary cutting tool having a monolithic carbide cutting member defining a carbide cutting head and a carbide shaft extending outwardly from the cutting head. The shaft includes a conduit in fluid communication with a port for delivering coolant and/or lubricating fluid to an interface between the cutting tool and a work piece. The cutting head defines a peripheral portion and a plurality of carbide cutting edges alternating with flutes in the peripheral portion. The cutting head, the shaft, and the cutting edges are formed integrally with one another. A shank portion defines an elongated bore, and the shaft is received in the bore in a shrink-fit relationship, wherein the shaft of the cutting member is fixed against movement relative to the shank portion.

### FIELD

An example implementation of the disclosure relates to a system for developing a modular cutting tool arrangement, and in particular, to a modular reamer system having shrink-fit components.

### BACKGROUND

Modular rotary cutting tools, such as modular reamers, typically include two pieces, namely, a reamer portion and a shank portion. The reamer portion generally includes a head having a shaft in the shape of a tapered cone extending therefrom. This shaft is inserted into the bore of a shank member, and one or more screws are used to attach the reamer portion to the shank portion. The reamer head typically has outwardly projecting blade portions with cutting edges which alternate with valley portions, or, flutes.

A reamer head may be constructed of steel and may include a series of steel blade pockets positioned about the circumferential edge of the reamer head. These pockets may each include a cutting edge member seated in pocket, and such cutting edge members may be carbide and are typically brazed to the pockets to hold them in place. A potential concern for this type of construction of a reamer head may include limitations in the ability to apply one or more coatings to the reamer head for improving the life and/or operational characteristic of the reamer head. For example, such coatings may include, without limitation, use of physical vapor deposition and/or chemical vapor deposition processes. Because of the temperatures required for such coating processes, and in order to minimize dimensional changes in the brazed construction during and/or following the coating processes, the dimensional range of the reamer head may be limited. Additionally, the selection of brazing materials may become limited to those that can withstand the temperatures of the coating process without unduly degrading in some manner. In some instances, the coating process may approach or exceed brazing temperatures (which may be the case with certain chemical vapor deposition coatings), in which case such coating process may not be readily usable on a brazed reamer head due to the potentially detrimental effect of the coating process on the reamer head.

Flutes between the pocketed cutting edge members provide clearance for evacuation of chips removed from a work piece during operation of the reamer head. Generally, it is desirable to maximize the number of cutting edges and flutes about the circumferential edge of the reamer head in order to increase cutting efficiency. Accordingly, the space required for the pockets and brazing impacts the number of cutting edges and flutes which can be spaced about the finite length of the reamer head's circumferential edge.

Additionally, because of the various materials used in such a modular reamer, namely, steel, carbide, brazing material, etc., the reuse, refurbishment and/or recycling of worn reamer heads may be problematic, given the reamer's mixed material components.

In view of these considerations, significant barriers may exist in maximizing the number of cutting edges on a rotary cutting tool and/or in its reuse, refurbishment and/or recycling.

### SUMMARY

In example implementations, solutions to the forgoing barriers are addressed by a modular reamer system and methods disclosed herein, implementations of which provide rotary cutting tools and methods for making rotary cutting tools.

One example implementation of the present disclosure includes a rotary cutting tool having a longitudinal axis and comprising a monolithic, or solid, carbide cutting member defining a carbide cutting head and a cylindrical carbide shaft having a shaft conduit. The shaft extends outwardly from the cutting head and is generally coaxially with the longitudinal axis. The cutting head defines a peripheral portion and a plurality of carbide cutting edges alternating with flutes in the peripheral portion. The cutting head, the shaft, and the cutting edges are formed integrally with one another. The shaft conduit is in fluid communication with a port, such that coolant and/or lubricating fluid can be delivered from the cutting tool to a work piece.

In another aspect, a shank portion is provided and defines an elongated bore extending generally coaxially with the longitudinal axis. The cutting head shaft is received in the bore of the shank portion in a shrink-fit relationship, wherein the shaft of the cutting member is fixed against movement relative to the shank portion.

In one example, the shaft conduit may extend generally coaxially with the longitudinal axis, and the shank portion defines a shank conduit in fluid communication with the shaft conduit and the cutting head port.

In one example, the cutting head defines a cutting head face extending generally radially outwardly with respect to the longitudinal axis, and the cutting head defines at least one port in fluid communication with the shaft conduit.

In other examples, the shank portion may be steel, such as H13 steel, and the cutting head could be a reamer.

In another example implementation of the present disclosure includes a rotary cutting tool having a longitudinal axis and comprising a monolithic, or solid, cermet cutting member defining a cermet cutting head and a cylindrical cermet shaft having a shaft conduit. The shaft extends outwardly from the cutting head and is generally coaxially with the longitudinal axis. The cutting head defines a peripheral portion and a plurality of cermet cutting edges alternating with flutes in the peripheral portion. The cutting head, the shaft, and the cutting edges are formed integrally with one another. The shaft conduit is in fluid communication with a port, such that coolant and/or lubricating fluid can be delivered from the cutting tool to a work piece.

Also disclosed is an example method of making a rotary cutting tool, including the steps of: providing a monolithic carbide member having a carbide cutting head, carbide cutting edges, and a carbide shaft of a first diameter having a shaft conduit, with the cutting head, the shaft, and the cutting edges being integral with one another; providing a steel shank portion that defines an elongated bore of a second diameter (which is less than or approximately equal to the first diameter of the shaft at room temperature) extending generally coaxially with the longitudinal axis; heating the shank portion to a temperature sufficient to cause the second diameter to be greater than the first diameter, and then, after the heating of the shank portion, inserting the shaft of the cutting head into the bore of the shank portion. The method also includes cooling the shank portion sufficiently to cause the bore of the shank portion to be in shrink-fit engagement with the shaft of the cutting member, wherein the shaft of the cutting member is generally fixed against movement with respect to the shank portion.

In one example, the method includes maintaining the shaft of the cutting head at approximately room temperature prior to the step of inserting the shaft of the cutting head into the bore of the shank portion.

In one example, the method includes heating the shank portion to between approximately 300 to 800 degrees Fahrenheit.

In an example, a method includes heating the first shank portion to a temperature sufficient to cause the second diameter to be greater than the first diameter, removing the shaft from the bore, and then reshaping the cutting head into a reshaped cutting head having a shaft of a third diameter.

In another example, wherein the second diameter is less than or approximately equal to the third diameter of the shaft of the reshaped cutting head at room temperature, and wherein, after the step of reshaping the cutting head, the method includes heating the first shank portion to a temperature sufficient to cause the second diameter to be greater than the third diameter, and inserting the shaft of the reshaped cutting head into the bore of the first shank portion. The method may then include cooling the first shank portion sufficiently to cause the bore of the first shank portion to be in shrink-fit engagement with the shaft of the reshaped cutting member, wherein the shaft of the reshaped cutting member is generally fixed against movement with respect to the first shank portion.

In one example, the method includes providing a second shank portion defining a bore of a fourth diameter, the fourth diameter being less than or approximately equal to the third diameter of the shaft of the reshaped cutting member at room temperature. The second shank portion is heated to a temperature sufficient to cause the fourth diameter of the bore of the second shank portion to be greater than the third diameter of the shaft of the reshaped cutting member, and the shaft of the reshaped cutting head is inserted into the bore of the second shank portion. The second shank portion may then be cooled sufficiently to cause the bore of the second shank portion to be in shrink-fit engagement with the shaft of the reshaped cutting member, wherein the shaft of the reshaped cutting member is generally fixed against movement with respect to the second shank portion.

It is to be understood that for a given example set forth herein, such example may include at least a portion of the subject matter of one or more of any other examples also set forth herein.

These and other examples are described in greater detail in the detailed description which follows.

### BRIEF DESCRIPTION OF THE DRAWINGS

Having thus described examples of the disclosure in general terms, reference will now be made to the accompanying drawings, which are not necessarily drawn to scale, and wherein like reference characters designate the same or similar parts throughout the several views, and wherein:

FIG. 1 is a perspective view of an example modular reamer system according to one implementation described herein.

FIG. 2 is a sectional view taken along lines 2--2 of FIG. 1;

FIG. 3 is an elevational view from the left of an example modular reamer system according to one implementation disclosed herein;

FIG. 4 is an elevational view from the right of an example modular reamer system according to one implementation disclosed herein;

FIG. 5 is a perspective view of an example modular shank for a modular reamer system according to an example disclosed herein;

FIG. 6 is a perspective view of an example cutting tool, such as a modular reamer head, for a modular reamer system according to an example disclosed herein;

FIG. 7 is schematic illustration of an example modular shank for a modular reamer system according to an example disclosed herein; and

FIG. 8 is a perspective view of another example cutting tool, such as a modular reamer head, for a modular reamer system according to the present disclosure.

### DETAILED DESCRIPTION

Implementations described herein can be understood more readily by reference to the following detailed description and examples and their previous and following descriptions. Elements, apparatus and methods described herein, however, are not limited to the specific implementations presented in the detailed description and examples. It should be recognized that these implementations are merely illustrative of the principles of the present disclosure. Numerous modifications and adaptations will be readily apparent to those of skill in the art without departing from the spirit and scope of the present disclosure.

Whenever the term “about” or “approximately” is used herein or in the appended claims to modify the dimensions of a feature of an implementation of the present disclosure, it is to be construed as referring to the parameters related to the relevant feature. Whenever a range is used herein or in the appended claims to describe dimensions, temperatures, times, amounts, or the like relating to a feature of an aspect of the present disclosure, the range is to be construed as including the stated end points of the range and every point therebetween.

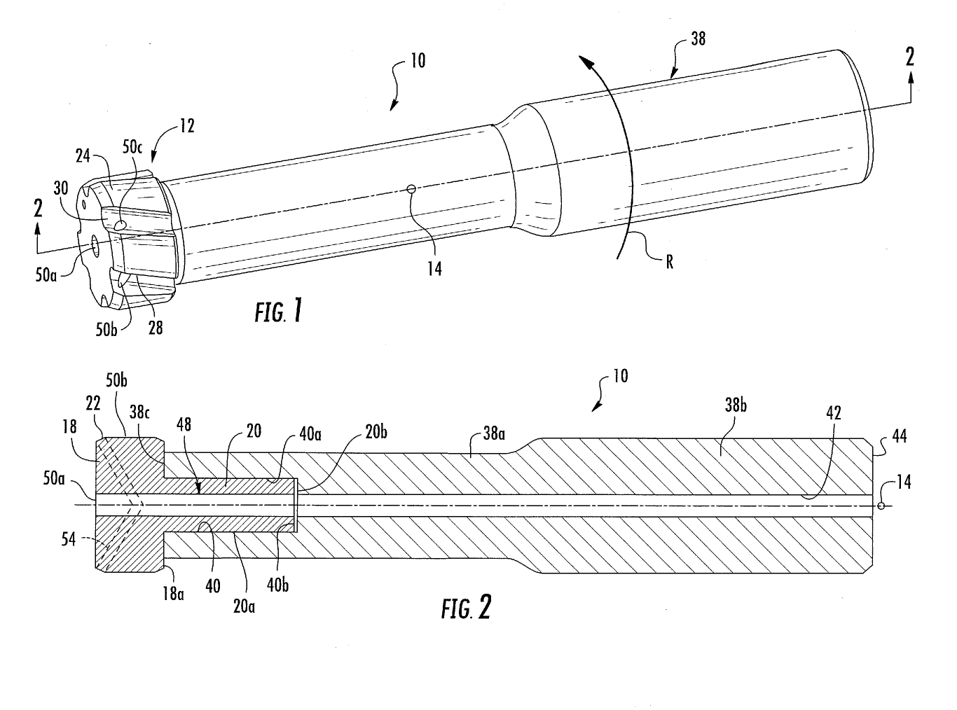

FIG. 1 illustrates an example implementation of a rotary cutting tool, and in particular, a modular reamer system in accord with the present disclosure. Modular reamer system, or “reamer system,” generally 10, includes a carbide or cermet rotary cutting tool, or “cutting tool,” generally 12, having a longitudinal axis 14.

Cutting member, or tool, 12 is in one example a monolithic, or solid, carbide or cermet member defining a carbide cutting head 18 and an axially projecting cylindrical carbide shaft 20, having a first diameter. Cutting head 18 is generally disc-shaped and defines a peripheral portion, or circumferentially-extending edge, generally 22. Formed into and integral with cutting head 18 are carbide blades, generally 24, each having at least one carbide cutting surface, or edge, 28. A flute 30 is defined between adjacent blades 24, and flutes 30 alternate with blades 24 about the peripheral portion, generally, 22 of cutting head 18. Although cutting head 18 is shown in the drawing as having left-hand flutes 30 for rotation in a counterclockwise direction as shown by the arrow R in FIG. 1, it is to be understood that the present invention is not limited to such left-hand orientation and that cutting head 18 could have right-hand fluting, straight fluting and/or fluting of other orientations.

Cutting head 18, shaft 20, blades 24, and cutting edges 28 are in one example all formed integrally with one another from a monolithic, or solid, portion of carbide (such as by cutting, milling, molding, drilling, boring, filing, sanding, etching and/or reaming, etc. operations).

In another example a cutting head 18 could be constructed from a monolithic, or solid, cermet member, with cutting head 18, shaft 20, blades 24, and cutting edges 28 all formed integrally with one another from a monolithic, or solid, portion of cermet (such as by cutting, milling, molding, drilling, boring, filing, sanding, etching and/or reaming, etc. operations).

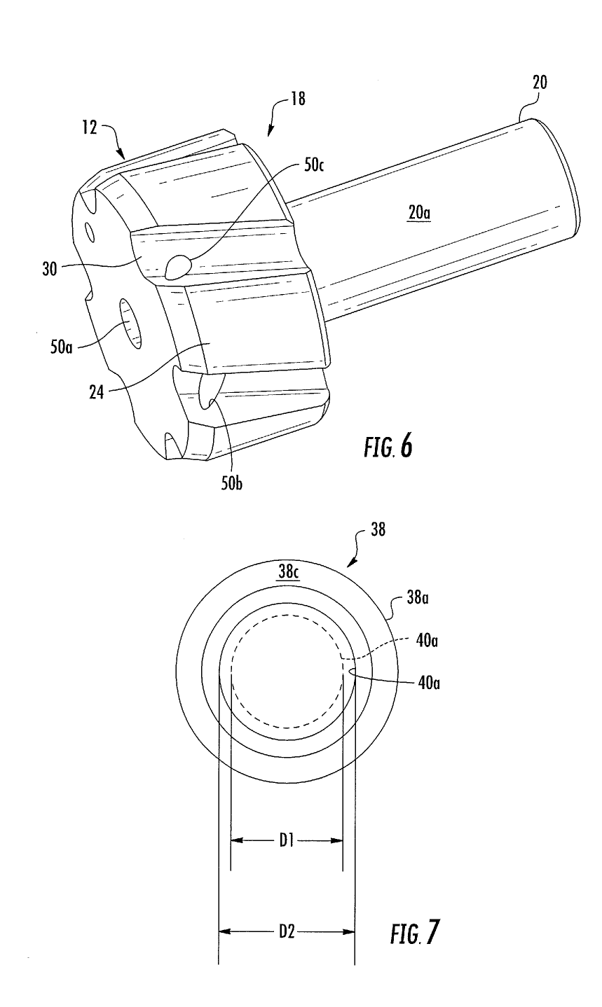

As shown in FIG. 2, shank portion 38 may include a smooth, cylindrical, elongated bore 40, of a second diameter, extending generally coaxially with the longitudinal axis 14. In modular fashion, shaft 20 of cutting tool 12 is received in bore 40 in a shrink-fit relationship discussed in more detail below, wherein the shaft 20 is substantially fixed against rotational and longitudinal movement relative to the shank portion 38, and wherein in one example, rear face 18a of cutting head 18 abuts or is adjacent to forward face 38c of shank portion 38. A circumferentially-extending wall 40a of bore 40 is in a direct interference-fit contact relationship with the cylindrical exterior surface 20a (which in one example is a smooth surface) (FIG. 6) of shaft 20. Shaft 20 also includes a base surface 20b that may abut, or, as shown in FIG. 2, may be in proximity to, or spaced from the bottom surface 40b of bore 40.

In the figures, shank portion 38 is shown as having a first cylindrical portion 38a and a second cylindrical portion 38b, of a larger diameter than the first cylindrical portion 38a. It is to be understood that shank portion 38 is not limited to such configuration and could include a single cylindrical portion of constant diameter extending its entire length or one or more other profiles, if desired (none shown). In one example, shank portion 38 is made of tool steel, and could, in one implementation be made of H13 steel, although the shank portion is not limited to a particular type of steel.

As shown in FIG. 2, shank portion 38 may include a conduit 42 generally coaxial with longitudinal axis 14. Conduit 42 can be used to deliver coolant and/or lubricant (not shown) from the end face 44 of shank portion 38 to a corresponding shaft conduit 48 (which may extend generally coaxially with the longitudinal axis 14) in shaft 20. Conduit 48 may extend from base surface 20b of shaft 20 to one or more cutting head ports and are configured to for deliver coolant and/or lubricant fluids to during use of cutting tool 12.

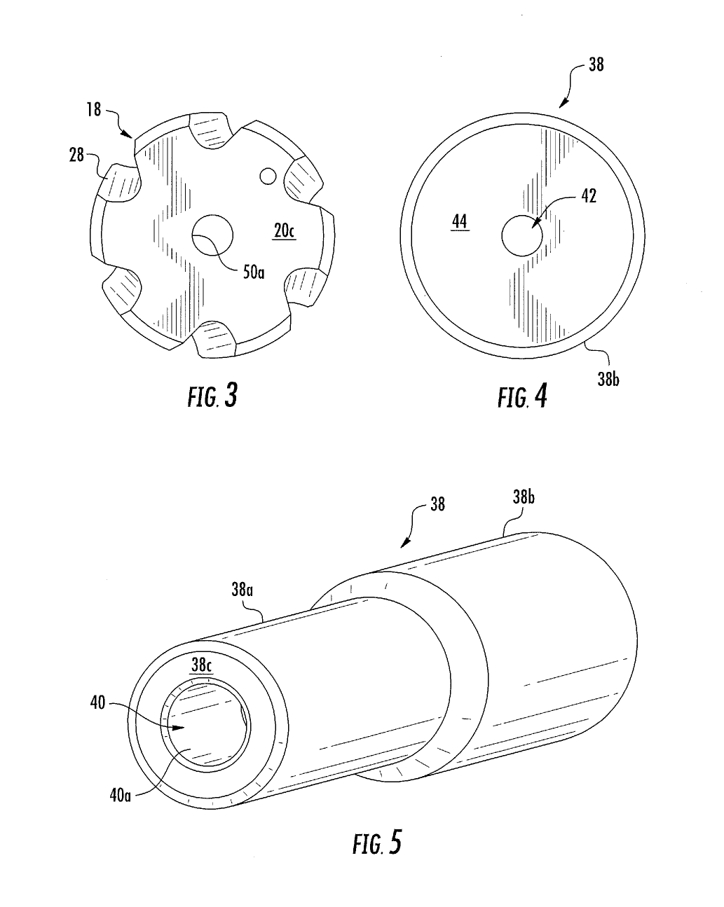

In one example, such as shown in FIGS. 2 and 6, the ports may include an axial port 50a (which is coaxial with longitudinal axis 14) in the end face 20c (FIG. 3) of cutting head 18 and/or radial conduits 54 supplying radial cutting head ports 50b and 50c (which extend radially outwardly with respect to longitudinal axis 14) in the peripheral portion 22 of cutting head 18. In particular, radial ports 50b and 50c serve to provide coolant fluid and/or lubricant fluid to cutting edges 28 regardless of the orientation of reamer system 10. Conduit 48 of cutting head 18 is in direct fluid communication with conduit 42, and the ports are in fluid communication with conduit 48. In one example, axial port 50a may be plugged in order to direct coolant and/or lubricant fluid solely through ports 50b and 50c. Similarly, in another example, ports 50b and 50c may be plugged in order to direct coolant and/or lubricant fluid solely through axial port 50a.

An example implementation also includes a method of making a modular rotary cutting tool, such as reamer system 10, by joining the modular components of cutting tool 12 and shank portion 38 together in a shrink-fit arrangement. Prior to cutting tool 12 and shank portion 38 being joined together, the internal diameter of bore 40 is slightly less than or equal to the external diameter of shaft 20 (when both cutting tool 12 and shank portion 38 are at room temperature, or at a temperature less than the maximum working temperature reached by reamer system 10 while working on a work piece (not shown)).

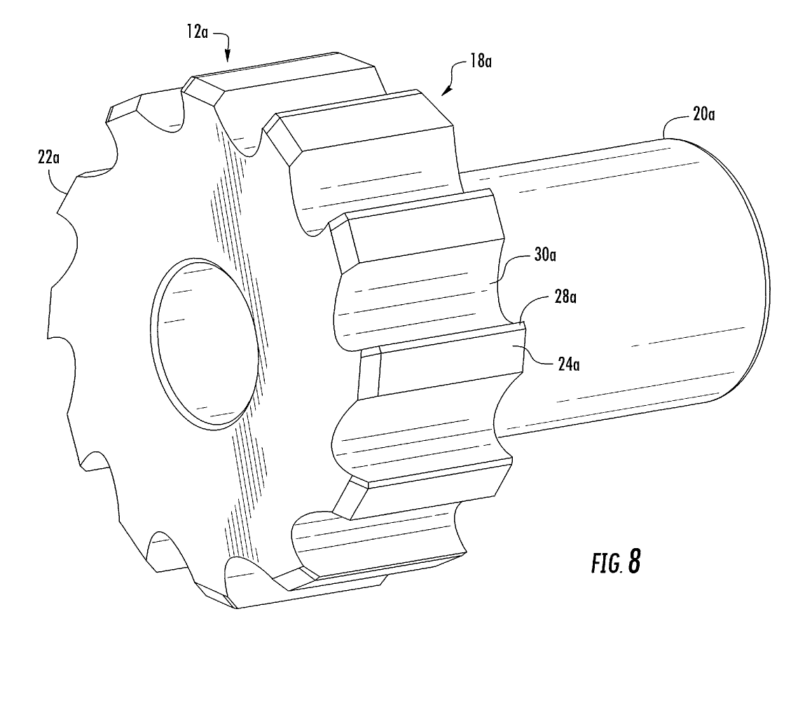

The method of joining cutting tool 12 and shank portion 38 together may include, with cutting tool 12 being at approximately room temperature, heating shank portion 38 to a temperature sufficient to cause the diameter D1 (FIG. 7) of bore 40 at room temperature (or at a temperature less than the maximum working temperature of reamer system 10) to increase to a diameter D2 (FIG. 7) sufficiently large enough for shaft 20 to be inserted into bore 40. In an example, if shank portion 38 is a steel component, shank portion 38 may be heated to between approximately 300 and 800 degrees Fahrenheit in order for the diameter of bore 40 to grow to the D2. Heating of shank portion 38 can be done in various ways, but one example implementation uses induction heating.

After the diameter of bore 40 reaches the D2 dimension, shaft 20 may then be inserted into bore 40, at which point, shank portion 38 may be cooled to room temperature (or to a temperature less than the maximum working temperature of reamer system 10), such that the diameter of bore 40 is about the D1 diameter, and wall 40a of bore 40 encompasses and bears against shaft 20 in a shrink-fit engagement. This shrink-fit engagement fixes cutting tool 12 against rotational movement with respect to shank portion 38. Once cutting tool 12 is received in bore 40 in this manner, both cutting tool 12 and shank portion 38 are thus fixed to one another as a unit, and modular reaming system 10 is formed. Shank portion 38 may be connected to a rotatable, driven tool, such as a driven spindle (not shown) and, in turn, drive cutting tool 12 for performing material cutting and removal on a work piece, which could be metal, wood, plastic, ceramic, or some other material.

It may be desirable to at some time separate cutting tool 12 from shank portion 38. This may be the case if cutting tool 12 becomes worn, obsolete, is needed in another application, etc. Whatever the reason for detaching cutting tool 12 from shank portion 38, an example implementation of the disclosure also includes an example method for separating cutting tool 12 from the shank portion 38. Such example method includes heating shank portion 38 together with cutting tool 12 carried in shank portion 38 to a temperature sufficient to cause the bore 40 diameter to increase from approximately the D1 dimension to the D2 dimension. This may mean, in one example, heating shank portion 38 to between approximately 300 and 800 degrees Fahrenheit. In the case of shank portion 38 being steel, the diameter of shaft 20 will typically grow less than the diameter of bore 40, because both carbide and cermet experience less thermal growth than do steel. Accordingly, once the diameter of bore 40 approximates the D2 dimension, shaft 20 may be removed from bore 40. Alternately, the cutting tool could be cooled as shank portion 38 is heated, if desired, in order to potentially speed up the process of developing a sufficient differential between the diameter of the shaft 20 and the diameter of the bore 40 for allowing shaft 20 to be withdrawn from bore 40.

Because in one example cutting tool 12 is entirely carbide or cermet, it may readily be reworked and/or reshaped to remain a tool of the same character, i.e., it remains a reamer tool, or it may be reshaped into another type of rotary cutting tool such as a milling tool (including without limitation an end mill), drilling tool, boring tool, burring tool, knurling tool, etc. Should cutting tool 12 be renewed or refurbished as the same type of tool or reshaped and/or reconfigured into another modular tool, it may also have its shaft 20 changed to another diameter, i.e., a third diameter. In such case, such a refurbished or remade cutting tool could be reinserted in a shank portion having a different bore diameter (i.e., a fourth diameter), and the methods for shrink-fitting the refurbished or remade cutting tool into a shank portion and/or removing it therefrom would be similar as those methods discussed above.

Also, as to recycling or reuse of modular reamer system 10 components, the cutting head 18 can be reused as discussed above, and shank portion 38 can similarly be reused in connection with other rotary cutting components, if desired. As to recycling specifically, because of the modular nature of the reamer system 10 components, the carbide (or cermet) and steel components can be readily segregated into specific material groupings, such as individual carbide, cermet and/or steel groupings, rather than being placed in mixed materials recycling paths. This could potentially result in increased recycling efficiencies.

Because blades 24 of reamer system 10 are integral with the peripheral surface 22 of cutting head 18, space-consuming blade pockets, cutting edges, and brazings (none shown) on such peripheral surface may be eliminated. Accordingly, by freeing up space on peripheral surface 22 formerly required by such pockets, brazings, etc., a significantly higher number of blades 24, cutting edges 28, and flutes 30 may be formed about peripheral surface 22. By way of a non-limiting example, FIG. 8 illustrates a cutting tool 12a a monolithic, or solid, carbide or cermet member defining a carbide cutting head 18a having a shaft 20a, a modular reamer cutting head 18a, and generally straight flutes 30a between blades 24a formed about peripheral surface 22a. Cutting edges 28a are provided on blades 24a. In this example, the number of flutes 30a which may be provided about peripheral surface 22a may be greater than the number of flutes which may otherwise be permitted about the same peripheral surface if pockets, brazings, etc. were required.

Cutting head 18 may, in one example implementation, include a coating, such as a physical vapor deposition and/or chemical vapor deposition coating, to improve and/or modify wear and operation. Because of the solid carbide (or solid cermet) construction used in an exemplary implementation, cutting head 18 may be subjected to the temperatures required for certain physical vapor deposition and/or chemical vapor deposition processes while still maintaining dimensional stability and tolerances of the flutes 30 and cutting edges 28.

While example implementations of modular rotary cutting tools have been disclosed, it is to be understood that the present disclosure is not limited to modular tools configured for rotary use and that application of the present disclosure to tools other than rotary cutting tools is contemplated herein.

Various implementations of the present disclosure have been described in fulfillment of the various objectives of the present disclosure. It should be recognized that these implementations are merely illustrative of the principles of the present disclosure. Moreover, although the foregoing descriptions and the associated drawings illustrate examples in the context of certain example combinations of elements and/or functions, numerous modifications and adaptations thereof will be readily apparent to those skilled in the art without departing from the spirit and scope of the present disclosure.

What is claimed is:

1. A rotary cutting tool having a longitudinal axis, the rotary cutting tool comprising:
a monolithic carbide cutting member defining a carbide cutting head and a cylindrical carbide shaft;
the shaft extending outwardly from the cutting head generally coaxially with the longitudinal axis;
the shaft defining a shaft conduit generally coaxially with the longitudinal axis extending for substantially the length of the shaft;
the cutting head defining a peripheral portion;
the cutting head defining a plurality of carbide cutting edges and flutes alternating with the cutting edges in the peripheral portion;
the cutting head defining at least one port in fluid communication with the shaft conduit;
the cutting head, the shaft, and the cutting edges each being formed integrally with one another;
a shank portion defining an elongated bore extending generally coaxially with the longitudinal axis; and
the shaft of the cutting member being received in the bore in a shrink-fit relationship, wherein the shaft of the cutting member is substantially fixed against movement relative to the shank portion.

2. The rotary cutting tool of claim 1, wherein the shank portion defines a shank conduit in fluid communication with the shaft conduit and the cutting head port.

3. The rotary cutting tool of claim 1, wherein:
the cutting head defines a cutting head face extending generally perpendicular to the longitudinal axis; and
the cutting head face defines at least one port extending generally coaxially with the longitudinal axis in fluid communication with the shaft conduit.

4. The rotary cutting tool of claim 1, wherein:
the cutting head defines at least one radial cutting head port extending generally radially outwardly with respect to the longitudinal axis in fluid communication with the shaft conduit.

5. The rotary cutting tool of claim 1, wherein the shank portion is steel.

6. The rotary cutting tool of claim 1, wherein the cutting head is a reamer.

7. The rotary cutting tool of claim 1, wherein the cutting head has a physical vapor deposition coating.

8. The rotary cutting tool of claim 1, wherein the cutting head has chemical vapor deposition coating.

9. A rotary cutting tool having a longitudinal axis, the rotary cutting tool comprising:
a monolithic cermet cutting member defining a cermet cutting head and a cylindrical cermet shaft;
the shaft extending outwardly from the cutting head generally coaxially with the longitudinal axis;
the shaft defining a shaft conduit generally coaxially with the longitudinal axis extending for substantially the length of the shaft;
the cutting head defining a peripheral portion;
the cutting head defining a plurality of cermet cutting edges and flutes alternating with the cutting edges in the peripheral portion;
the cutting head defining at least one port in fluid communication with the shaft conduit;
the cutting head, the shaft, and the cutting edges each being formed integrally with one another;
a shank portion defining an elongated bore extending generally coaxially with the longitudinal axis; and
the shaft of the cutting member being received in the bore in a shrink-fit relationship, wherein the shaft of the cutting member is substantially fixed against movement relative to the shank portion.

10. A method of making a rotary cutting tool, comprising:
providing a monolithic carbide member having a carbide cutting head, a plurality of carbide cutting edges, and a carbide shaft of a first diameter defining a shaft conduit generally coaxial with the longitudinal axis extending for substantially the length of the shaft; the cutting head, the shaft, and the cutting edges each being formed integrally with one another;
providing a shank portion defining an elongated bore of a second diameter extending generally coaxially with the longitudinal axis; the second diameter being approximately equal to the first diameter of the shaft at room temperature;
heating the shank portion to a temperature sufficient to cause the second diameter to be greater than the first diameter;
after the heating of the shank portion, inserting the shaft of the cutting head into the bore of the shank portion; and
cooling the shank portion sufficiently to cause the bore of the shank portion to be in shrink-fit engagement with the shaft of the cutting member, wherein the shaft of the cutting member is generally fixed against movement with respect to the shank portion.

11. The method of claim 10, further comprising maintaining the shaft of the cutting head at approximately room temperature prior to the step of inserting the shaft of the cutting head into the bore of the shank portion.

12. The method of claim 10, wherein the step of heating the shank portion includes heating the shank portion to between approximately 300 to 800 degrees Fahrenheit.

13. The method of claim 10, wherein the step of providing a monolithic carbide member having a cutting head includes providing the cutting head being configured as a reamer.

14. The method of claim 10, further comprising applying a physical vapor deposition coating to the cutting head.

15. The method of claim 10, further comprising applying a chemical vapor deposition coating to the cutting head.

16. A method of making a rotary cutting tool, comprising:
providing a monolithic cermet member having a cermet cutting head, a plurality of cermet cutting edges, and a cermet shaft of a first diameter defining a shaft conduit generally coaxial with the longitudinal axis extending for substantially the length of the shaft; the cutting head, the shaft, and the cutting edges each being formed integrally with one another;
providing a shank portion defining an elongated bore of a second diameter extending generally coaxially with the longitudinal axis; the second diameter being approximately equal to the first diameter of the shaft at room temperature;
heating the shank portion to a temperature sufficient to cause the second diameter to be greater than the first diameter;
after the heating of the shank portion, inserting the shaft of the cutting head into the bore of the shank portion; and
cooling the shank portion sufficiently to cause the bore of the shank portion to be in shrink-fit engagement with the shaft of the cutting member, wherein the shaft of the cutting member is generally fixed against movement with respect to the shank portion.

17. A method of making a rotary cutting tool, comprising:
providing a monolithic carbide member received in a bore of a first shank portion; the carbide member having a carbide cutting head, a plurality of carbide cutting edges, and a carbide shaft having a shaft conduit generally coaxial with the longitudinal axis extending for substantially the length of the shaft, each being formed integrally with one another; the shaft being of a first diameter and the bore being of a second diameter, the second diameter being approximately equal to the first diameter of the shaft;
heating the first shank portion to a temperature sufficient to cause the second diameter to be greater than the first diameter;
removing the shaft from the bore; and
reshaping the cutting head into a reshaped cutting head having a shaft of a third diameter.

18. The method of claim 17, wherein the second diameter is less than or approximately equal to the third diameter of the shaft of the reshaped cutting head at room temperature and further comprising:
after the step of reshaping the cutting head, heating the first shank portion to a temperature sufficient to cause the second diameter to be greater than the third diameter;
inserting the shaft of the reshaped cutting head into the bore of the first shank portion; and
cooling the first shank portion sufficiently to cause the bore of the first shank portion to be in shrink-fit engagement with the shaft of the reshaped cutting member, wherein the shaft of the reshaped cutting member is generally fixed against movement with respect to the first shank portion.

19. The method of claim 17, further comprising:
providing a second shank portion defining an elongated bore of a fourth diameter; the fourth diameter being less than or approximately equal to the third diameter of the shaft of the reshaped cutting member at room temperature;
heating the second shank portion to a temperature sufficient to cause the fourth diameter of the bore of the second shank portion to be greater than the third diameter of the shaft of the reshaped cutting member;
inserting the shaft of the reshaped cutting head into the bore of the second shank portion; and
cooling the second shank portion sufficiently to cause the bore of the second shank portion to be in shrink-fit engagement with the shaft of the reshaped cutting member, wherein the shaft of the reshaped cutting member is generally fixed against movement with respect to the second shank portion.

20. The method of claim 17, wherein the step of heating the first shank portion includes heating the cutting member and the first shank portion to between approximately 300 to 800 degrees Fahrenheit.

21. The method of claim 17, wherein the step of providing a monolithic carbide member having a cutting head includes providing a carbide member configured as a reamer.

22. The method of claim 17, wherein the step of reshaping the cutting head into a reshaped cutting head includes reshaping the cutting head into a reamer.

23. The method of claim 17, further comprising applying a physical vapor deposition coating to the cutting head.

24. The method of claim 17, further comprising applying a chemical vapor deposition coating to the cutting head.
